(19) United States
(12) Patent Application Publication
(10) Pub. No.: US 2007/0015578 A1
(43) Pub. Date: Jan. 18, 2007

(54) Game, apparatus, system, and method

(75) Inventor: Alfredo C. Fajardo, Marikina City (PH)

Correspondence Address: INTELLECTUAL PROPERTY LAW GROUP LLP, 12 SOUTH FIRST STREET, SUITE 1205, SAN JOSE, CA, 95113, US

(73) Assignee: VERITAS MOBILE SOLUTIONS PTE LIMITED

(21) Appl. No.: 11/472,871

(22) Filed: Jun. 21, 2006

(30) Foreign Application Priority Data
Jul. 6, 2005 (SG) 200504275-9

(51) Int. Cl. A63F 13/00

(52) U.S. Cl. 463/37

(57) ABSTRACT

A game apparatus, system, and method for playing a game is disclosed. The game is a numbers based game with the aim being to select the lowest unique number, although the game could be run for players to select a unique number the same as or closest to any number predetermined by the organiser. The game is played using communications devices such as mobile phones, so that players can input their number, and be informed when their selected number is no longer unique. At the end of the game, the user who has selected the lowest unique number is declared to be the winner.

### FIELD OF THE INVENTION

This invention relates to a game, and more particularly a numbers based game. In particular, this invention relates to a numbers based game that may be played using a communications medium such as that accessible by mobile phone.

### BACKGROUND ART

Various types of numbered based games are played by people throughout the world. A common theme in numbers games is that to win, a player must correctly select the numbers drawn by the game organiser. This is the case in a game known around the world as Lotto. In another game known as Housie or Bingo (and possibly also known under different names, depending on the country and local custom), a players are provided with a list of numbers, and the first player to cross off all the numbers in the list as drawn by the game organiser, is the winner.

This invention seek to provide an alternative to hitherto known games, and in particular a game that lends itself to play by mobile phone subscribers using their mobile phones.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with one aspect of the invention there is provided a game apparatus comprising processing means connected with memory means and input means, said input means receiving a communication from a user causing a number within a predetermined range to be input into said apparatus, where within a current game predetermined time-span, said memory means stores an identifier associated with each user who previously within said current time-span caused said number to be input, each said identifier being cross-referenced in said memory means against each said number previously input;

where on receipt of a number said processor means scans said memory means for numbers previously cross-referenced with identifiers,

and on determining said number has no cross-referenced identifier and is not otherwise invalid, said processor means cross-references the identifier associated with the user who input said number with said number in said memory means,

and on determining said number has been cross referenced against a said identifier, said processor means excludes said number as a valid number for the remainder of the predetermined current game time span;

where at the end of said current predetermined game time-span said processor means determines the identifier cross-referenced against, closest to, closest to and above, or closest to and below—a predetermined number to be the current game winner. A prize may be awarded to the winner, and minor prizes may be awarded to runners-up, at the discretion of the game organiser.

Preferably on determining said number has been cross referenced against a said identifier, said processor means determines said number as invalid and deletes the cross-referenced identifier.

Preferably the number is chosen and entered into the input means by the user. Alternatively the number may be generated by a random number routine run in said processor means.

Preferably the identifier cross-referenced against the predetermined number is determined to be the current game winner. Where there is no outright winner the game prize may jackpot or may be allocated by lottery.

Preferably said predetermined number is the lowest number within said predetermined range not marked as invalid.

The identifier may be a communications identifier such as a subscriber email address, a subscriber telephone number (mobile or landline), or the IMEI (International Mobile Equipment Identity) associated with a mobile phone, or other data concerning the user who input the number.

The numbers may be stored in a look-up table in said memory means, and said processor means arranged to store identifiers against each said number. Numbers determined as invalid may be marked as invalid by a flag stored against them in the look-up table. Alternatively all numbers are marked as valid by a flag stored against them in the look-up table, and those having no flag may be determined as invalid.

Preferably said look-up table includes a field for recording a second identifier associated with the user. In this manner two or more people my use the same. communications device or link, and the game apparatus can discriminate between them.

Preferably said input means is associated with input/output means.

Preferably said input/output means comprises a telecommunications link to a plurality of mobile phones which may selectively connect thereto.

Preferably said number is chosen and entered into the input means by the user using their mobile phone, by SMS (short message service).

Alternatively said number is chosen and entered into the input means by the user using their mobile phone, as a DTMF train in response to prompts issued by said processor means.

Preferably the number is chosen and entered into the input means by the user, and the game is associated with a transaction involving the user downloading a file. The file may be selected from a graphic image or sequence, or a ringtone. A fee may be charged for the download and/or separately to the user before the user can participate.

Preferably said processor means on determining said number as invalid, notifies the user associated with the identifier to which the number is cross referenced that the number is invalid, and notifies the user who presently entered the number that the number is unavailable, before deleting the cross-referenced identifier.

Preferably said processor means on cross-referencing the identifier with a valid number, informs the user that their selection has been successful.

Also in accordance with the invention there is provided machine readable media with instructions to program a computing device to operate as a game apparatus as described above.

Further in accordance with the present invention there is provided a system for playing a game, where the game participants comprise a plurality of users having communications devices, said communications devices having access to a telecommunications carrier, said telecommunications carrier being connected with a game apparatus as described above, via the input means of said game apparatus.

Preferably said telecommunications carrier is a mobile phone network, and said communications devices comprise mobile phones.

In accordance with a second aspect of the present invention there is provided a game operated by a facilitator and played by a plurality of users, during a current game predetermined time-span, during which users may have a number within a predetermined range cross-referenced with an identifier for the user recorded with the facilitator,

where when another user attempts to have another number recorded with the facilitator, the facilitator checks to see if said another number matches any said numbers already recorded,

and if not, records said another number as a said number cross referenced with the identifier of the user

and if so, excludes the another number as a valid number for the remainder of the current game predetermined time span,

where at the end of the current game predetermined time-span said facilitator determines the identifier cross-referenced against, closest to, closest to and above, or closest to and below—a predetermined number to be the current game winner. A prize may be awarded to the winner, and minor prizes may be awarded to runners-up, as determined by the facilitator.

Preferably on determining said number has been cross referenced against a said identifier, said facilitator determines said number as invalid and deletes the cross-referenced identifier.

Preferably the number is chosen and entered into the facilitator by the user. Alternatively the number may be generated by a random number generator operated by said facilitator.

Preferably the identifier cross-referenced against the predetermined number is determined to be the current game winner. Where there is no outright winner the game prize may jackpot or may be allocated by lottery.

Preferably said predetermined number is the lowest number within said predetermined range not marked as invalid.

The identifier may be a communications identifier such as a subscriber email address, a subscriber telephone number (mobile or landline), or the IMEI (International Mobile Equipment Identity) associated with a mobile phone, or other data concerning the user who input the number.

The numbers may be stored in a look-up table operated by said facilitator, with the facilitator recording identifiers against each said number. Numbers determined as invalid may be marked as invalid by a flag stored against them in the look-up table. Alternatively all numbers are marked as valid by a flag stored against them in the look-up table, and those having no flag may be determined as invalid.

Preferably said look-up table includes a field for recording a second identifier associated with the user. In this manner two or more people my use the same communications device or link, and the game apparatus can discriminate between them.

Preferably said users communicate with said facilitator using telecommunications devices over a telecommunications link operated by a telecommunications carrier

Preferably said communications devices comprise mobile phones.

Preferably said number is chosen and communicated to said facilitator by the user using their mobile phone, by SMS (short message service).

Alternatively said number is chosen and communicated to said facilitator by the user using their mobile phone, as a DTMF train in response to prompts provided by said facilitator.

Preferably the number is chosen and communicated to said facilitator by the user, and the game, is associated with a transaction involving the user downloading a file provided by the facilitator. The file may be selected from a graphic image or sequence, or a ring tone or both. The graphic image or ring tone may represent a character from a cartoon or movie. The category of download may be recorded by the facilitator and incorporated into the game, insofar as there may be for example, four characters, and a game of the type described above played in relation to each character. This would require a separate field in the look-up table to record the character, with each character effectively constituting a category. Prior to determining the winner, a lottery would be operated to select the category that the winner was to be selected from, before the current game winner is determined.

Preferably said facilitator on determining said number as invalid, notifies the user associated with the identifier to which the number is cross referenced that the number is invalid, and notifies the user who presently entered the number that the number is unavailable, before deleting the cross-referenced identifier.

Preferably said facilitator on cross-referencing the identifier with a valid number, informs the user that their selection has been successful.

The facilitator may be a telecommunications carrier or independent from the telecommunications carrier.

### BRIEF DESCRIPTION OF THE DRAWINGS

A preferred embodiment of the invention will now be described in the following description, made with reference to the drawings, in which:

FIG. 1 is a diagram showing the game apparatus and system according to the embodiment; and

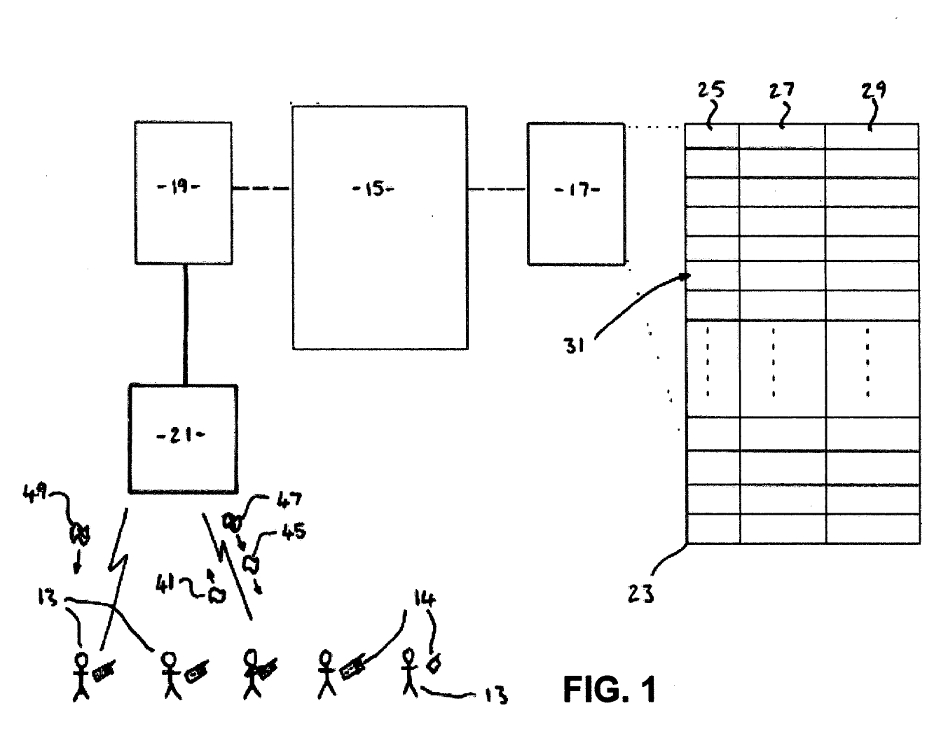

FIG. 2 is a flowchart setting out processor operation when a user enters a number into the game apparatus.

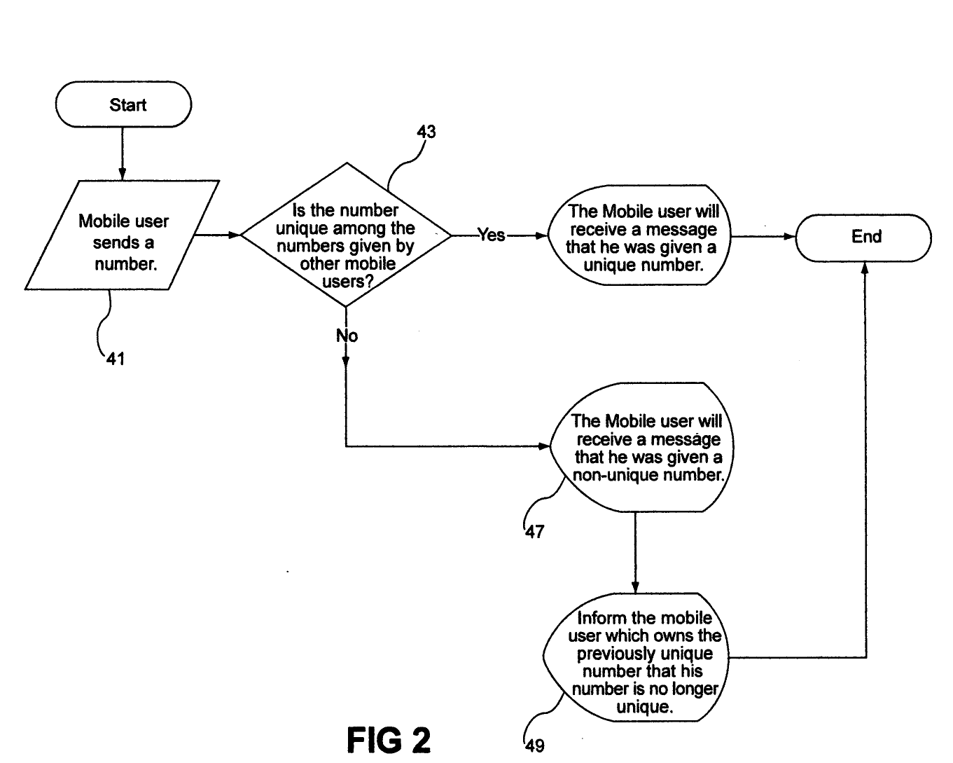

### BEST MODE(S) FOR CARRYING OUT THE INVENTION

The embodiment is a game apparatus 11 and system for a plurality of users 13 having mobile phones 14. The game apparatus 11 has processing means in the form of a CPU 15 connected with memory means in the form of ram 17, and an input/output device 19 capable of sending and receiving data. The input/output device is interfaced with a mobile phone network 21, which in turn, is accessible by the users 13 using their mobile phones.

The ram 17 stores a look-up table 23 having data fields shown as columns 25, 27, and 29. The data fields comprise identifiers in the form of first identifiers 27 which are user phone numbers recorded against numbers 25 selected by the users, and second identifiers 29 which comprise a user entered identifier of a user, which may be optionally entered by the user where the user may not own the phone used to complete the transaction, or where the user wants to make an entry in the game on behalf of another party.

The game is played over a predetermined period of time. At the end of the period, the game ends and the winner is determined. The aim of the game is for the user to select the lowest unique number, that is the lowest number not selected by any other user. The game apparatus achieves this in the manner described below.

In use the ram 17 will record the user phone number in the identifier field 27, against a number selected by the user 13, the number being recorded by cross-reference with the phone number. As numbers are successfully allocated to users, the users are informed via the mobile phone network. For ease of understanding the cross-reference is illustrated as a row (for example, row 31) in the table 23.

As the game proceeds the table will be populated with user phone numbers cross-referenced with selected numbers, and possibly with second identifiers if selected by the phone user. When a user selects a number already selected by another user, the number is taken out of the game, being marked as invalid. The CPU 15 causes messages to be sent to both users who selected the number, informing them that the number is out of the game. The users will each have to enter another number to remain in the game.

At the end of the predetermined period of time, the game is ended with all further entries suspended, and the lowest valid number in the table is determined. The winner is identified from the second identifier if present and if not identification of the winner defaults to the first identifier. The winner is then notified via the mobile phone network. A prize may be awarded to the winner, and minor prizes may be awarded to runners-up, at the discretion of the game organiser.

It will be appreciated that there are many ways in which a number can be marked as invalid. This may be achieved by replacing the first and or second identifier with a number string which is recognised as an invalid identifier. Alternatively a further field could be added with values set to “0” for valid numbers, and changed to “1” for invalid numbers.

It should be appreciated that the table may store all possible numbers within the predetermined range, and enter identifiers in the identifier fields, as the numbers are selected by users.

In operation, a mobile phone user submits an entry into the game by sending an SMS message 41 to a recipient associated with the game facilitator. The SMS message contains a non-negative, non-zero number. The mobile phone user sends this number believing that this is the lowest unique number. Furthermore, the mobile phone user can send different numbers to increase his chances of getting the lowest unique number, however only one number can be sent per SMS message.

Upon receiving the message containing the number from the mobile phone user, the game application will determine 43 if the number is unique among the numbers given by other mobile phone users. If the number is unique, the game application will send an SMS message 45 informing the mobile phone user that he has submitted a unique number.

If the submitted number matches a previously unique number already sent by a mobile phone-user, the game application will send an SMS message 47 back to the mobile phone user informing that he has submitted a non-unique number. Furthermore, the game application will also submit an SMS message 49 to the mobile phone user owning the previously unique number that their submitted number is no longer unique. This mobile user will need to submit another entry in the game.

At the end of the game period, the game application will extract the lowest unique number, and the mobile phone user who owns that number is declared the winner and notified.

A typical commercial application may involve the selling of pictures being extracts of characters appearing in a comic strip. The game may be promoted in the publication in which the comic strip appears, possibly a newspaper. A mobile phone user may select from a number of such pictures, and download the picture of their choice, for a fee which is debited from their account. The account may be prepaid or credit.

Prior to the user participating and being charged for the download, there is a registration procedure to ensure that under-age users cannot participate. The user personalises the picture with a number they may select, the number being in the range from 1 to 99,999,999. Once registered, system informs subscriber if number in the logo he downloaded is no longer unique. The subscriber can then download another picture with a different number. At the end of the game time span, the picture having the lowest unique number wins a cash prize. The game time span is envisaged to be about two to three days, with about three games run every week, although games may be run over longer periods if desired.

It should be appreciated that the invention is not limited to this specific example illustrating a form of character merchandising. The game may be run in tandem with any promotion, or as stand alone. The game may also have a casino application with a fee for entry, and short game time span.

1. A game apparatus comprising processing means connected with memory means and input means, said input means receiving a communication from a user causing a number within a predetermined range to be input into said apparatus, where within a current game predetermined time-span, said memory means stores an identifier associated with each user who previously within said current time-span caused said number to be input, each said identifier being cross-referenced in said memory means against each said number previously input;
where on receipt of a number said processor means scans said memory means for numbers previously cross-referenced with identifiers,
and on determining said number has no cross-referenced identifier and is not otherwise invalid, said processor means cross-references the identifier associated with the user who input said number with said number in said memory means,
and on determining said number has been cross referenced against a said identifier, said processor means excludes said number as a valid number for the remainder of the predetermined current game time span;
where at the end of said current predetermined game time-span said processor means determines the identifier cross-referenced against, closest to, closest to and above, or closest to and below—a predetermined number to be the current game winner.

2. A system for playing a game, where the game participants comprise a plurality of users having communications devices, said communications devices having access to a telecommunications carrier, said telecommunications carrier being connected with a game apparatus as claimed in claim 1, via the input means of said game apparatus.

3. A game operated by a facilitator and played by a plurality of users, during a current game predetermined time-span, during which users may have a number within a predetermined range cross-referenced with an identifier for the user recorded with the facilitator,
where when another user attempts to have another number recorded with the facilitator, the facilitator checks to see if said another number matches any said numbers already recorded,
and if not, records said another number as a said number cross referenced with the identifier of the user
and if so, excludes the another number as a valid number for the remainder of the current game predetermined time span,
where at the end of the current game predetermined time-span said facilitator determines the identifier cross-referenced against, closest to, closest to and above, or closest to and below—a predetermined number to be the current game winner.
